(19) United States
(12) Patent Application Publication
(10) Pub. No.: US 2012/0138166 A1
(43) Pub. Date: Jun. 7, 2012

(54) ANTI-COKING PROCESS AND EQUIPMENT FOR OILING WASTE RUBBER OR WASTE PLASTIC, AND COKING REMOVER

(76) Inventor: Bin Niu, Jinan (CN)

(21) Appl. No.: 13/383,458

(22) PCT Filed: Sep. 30, 2009
(86) PCT No.: PCT/CN2009/074341

§ 371 Date: Feb. 22, 2012

(30) Foreign Application Priority Data
Jul. 15, 2009 (CN) 200910016783.1
Jul. 15, 2009 (CN) 200910016785.0

(51) Int. Cl. F17D 1/04

(52) U.S. Cl. 137/334

(57) ABSTRACT

An anti-coking process is provided for oiling the rubber or plastic waste, and it involves the pyrolysis process that comes with the emission of hot air to be mixed with the high-temperature hot air that is ready to be sent into pyrolysis device. The equipment described includes a return air pipeline being connected to the hot air outlet. Meanwhile, a coking cleaning device is also introduced to remove the coke residual on the pyrolysis device wall in the cracking process. This device consists of a scraper, which, through the role of weights, is able to work with the inside surface of the cracking device.

### FIELD OF THE INVENTION

This present invention involves a kind of anti-coking process and equipment. Specifically, it is a kind process and equipment applied for oiling device and the automatic coking remover.

### BACKGROUND OF THE INVENTION

It is well-known that the rubber and plastic wastes, after being cracked down, are able to further generate gasoline, diesel and other products. This is effective to provide a good solution for the treatment of industrial wastes such as rubber and plastic from waste tires that are massed produced in the modern social environment. Moreover, it also provides a new program to improve the resource depletion and energy shortage.

Generally, the treatment involves the use of cracking device to achieve the above purpose, subject to an operating temperature of approximately 450°. As the heating temperature is required to be higher than the cracking temperature, this heating condition may lead to the formation of coking on the inner wall of the cracking device. To make it worse, the coking status may get more as the temperature increases, resulting in a lot of harmful effects to the inner wall of the cracking device. For example:

1. Coking may prevent heat transfer into the materials in the pyrolysis device, thereby reducing the thermal efficiency.

2. As the heat transfer is impeded, it is a must to improve the temperature of hot air to ensure that pyrolysis temperature of the material in the cracking device. Thus, not only the fuel consumption increases, the increased heating temperature may greatly reduce the life of the cracking device.

3. The coking formed inside the cracking device may continue to grow, thus impeding the flow of materials. And the increased pressure difference will affect the movement of materials in the cracking inside, and also consume more energy.

4. The coking may affect the materials in the pyrolysis reaction, and produce unwanted side effects, thus affecting the harvest rate of the final product. As a result, to achieve the same target product requires more consumption of raw materials and energy.

For the above mentioned reasons, the presence of coke can cause the failure in the cracking of continuous industrial production, and lead to serious security risks to production and equipment.

### CONTENT OF INVENTION

Regarding the coking problem that may be found in the production process of oiling equipment, this present invention provides a kind of technology that is effective in automatically preventing and removing the coking with energy saving. Specifically, it involves the use of a thermal recovery system to reduce the reaction thermal difference and a process and equipment that comes with a special coking remover built in the cracking device. At the same time, an automatic equipment removing coking is designed by using the hot air out of the pyrolysis process, which is mixed with the high-temperature hot air ready to be sent in the cracking device, so as to reduce the temperature difference inside. This process takes full advantage of the residual heat in the cracking device to adjust the reaction temperature in the whole pyrolysis. As a result, the temperature difference greatly decreases, and able to prevent the coking from presence in the pyrolysis process. Thus, the increased reaction efficiency reduces the workload of equipment and extends its life span. Due to this, the production cost and energy consumption can both be saved.

The present invention has the coking removing process that is achieved as follows:

An anti-coking process mainly involves using the hot air out of the pyrolysis process, which is mixed with the high-temperature hot air ready to be sent in the cracking device, so as to reduce the temperature difference inside the pyrolysis device.

As we all know, a cracking device is basically comprised of a rotary inner cylinder, in which the coking requires a minimum reaction temperature. Below this valve, coking does not occur. Therefore, anti-coking technology is mainly applied to cracking device or a section of the cracking device where its temperature is higher than the coking temperature. Between the material entry and the product exit of the cracking device, the distribution of the thermal energy may be not so uniform that a large difference comes along in the reaction process. This contributes primarily to the occurrence of coking. That means that solution of this problem will provide the optimum condition for coking prevention.

Meanwhile, to prevent the coking from being present inside the cracking device for any other reasons, especially on the inner wall of the inner chamber, this present invention introduces an automatic coking remover, which is placed on the inner wall of the cracking device, and able to complete the continuous automatic operation. In this way, coking presence resulting from other reasons can be removed at any time, thus clearing the problem on the current process which requires the production to be suspended before removing operation is done, as that may seriously affect the production schedule. The process of continuous removal ensures that the cracking device or other oiling equipment is free from any coking in the chamber. This not only reduces the burden on operation, but also raises the thermal efficiency, avoiding the loss of life span of the inner wall of the equipment caused by coking; generally, it is achieved as follows: The cracking device has a scraper set on the remover that is adaptable to the inner wall of the cracking device in coking removal. The match between the scraper and the inner wall may bring along the rotation of the cracking device or optimize the rotation of the equipment. To increase the efficiency, the selected scraper is adaptable to the surface of the inner wall, and works continuously on it. Thus, as the inner wall of the oiling equipment is found with shape changes or there is any other reasons that may impede the work of a scraper, the scraper can be self-adjusted to avoid the damage to the inner wall, and better to ensure its life span.

This present invention is mainly aimed at using the hot air chamber to heat the cracking device. Hot air in the chamber is here to achieve the recovery of the thermal energy. Principally, the way to lessen the temperature difference is achieved by using the following equipment: cracking device including the outer wall and a rotary inner cylinder, between which is set with a hot air chamber. The outer wall of the chamber is designed with one or more hot air outlets, at which a valve is equipped for air flow control. Through the same pipeline, all the hot air outlets are connected to the inlet mixing chamber, which has a heating inlet and is connected to the hot air inlet.

The aforementioned mixing chamber can be either an independent chamber, or part of the air outlet pipeline of the heating device. This design ensures that the hot air at the outlet is sent via pipeline to the inlet mixing chamber. After being mixed with the high-temperature gas out of the heating device, it will come back to the hot air chamber as the heat source for the pyrolysis reaction. In this way, the recovery of hot air is done. At the outlet, the temperature of hot air is lower than the valve as required for the cracking reaction, but up to 400-420°. The prior way is to discharge it or apply it as an alternative heat source. In this present invention, it is conveyed via the pipeline into the inlet mixing chamber, where it is mixed with the hot air in the heating device. As the air in the device may go up to a temperature of 1300° or higher, the direct entry into the hot air chamber of the cracking device may result in the dramatic rise of the temperature in the inner cylinder, compared to the heating temperature of 500-550° required for the cracking section. Consequently, the material in moving may encounter a large amount of coking part, which is attached to the inner wall of the cracking device. If using the process provided in this present invention, hot air at the outlet of the cracking device comes into the inlet mixing chamber via pipeline, and got mixed with the hot air in the heating device, effectively reducing the temperature of the air in the heating device. As both airs greatly differ in temperature, they may form an air swirl in the inlet mixing chamber, enabling both airs to have heat transferred in a short period of time. This naturally leads to the temperature deduction of the hot air before entering the hot air chamber. Often the required temperature valve can be reached. This can greatly reduce the temperature difference between the materials inlet and the product outlet by 400-500°. In this way, the coking phenomenon caused by the large temperature difference is resolved to achieve the prevention effects, thus avoiding the treatment in response to the coking presence.

To meet the process requirements, the hot air coming out of the cracking device needs, after the adjustment of the air volume, to be mixed with the high-temperature hot air. Specifically, the hot air at the outlet may be discharged, resulting in the temperature decrease of the cracking device. To prevent this, the air flow adjustment valve for each of the hot air outlet is designed with a temperature control device. As the temperature of the cracking section goes to too low a level, the adjustment valve is closed to raise the temperature in the cracking device. Otherwise, the adjustment valve is opened to release the hot air back to the heating device. This ensures the temperature balance in the whole cracking process, whilst reducing the instant heating and cooling that may result in coking. Additionally, the heat carried with the hot air can be utilized maximally: As mentioned above, the hot air temperature in the heating device usually goes up to 1300° or higher. To allow it goes down, it is required to be mixed with large amount of low-temperature hot air at the outlet. For this purpose, air adjustment device is set on the hot air return pipeline. Generally, a hot air recovery fan (or air pump) is preferred. Thus, the flow of low-temperature hot air is increased to achieve the purpose of effectively cooling the hot air in the heating device, as required for the process. Likewise, when the flow of hot air is too much and it causes the excessive cooling, a separate exhaust pipeline may be designed on the hot air recovery fan. If the hot air is found excessive at the product outlet of the cracking device, it can be used for other purpose when coming through the fan. In this way, the thorough recovery for utilization of heat energy can be achieved to avoid any waste.

The above equipment can provide effect prevention the coking of cracking device. To prevent this problem that may be caused by other reasons, especially one that occurs to the inner wall of the inner cylinder, the cracking device has a special coking remover to remove such coking. The specific structure is as below:

The mentioned cracking device has a rotary cylinder that is mounted to the fixing seal at both ends. In the inner cylinder is set with an arm support fixed to the seal, and with a rocker being connected to the support arm in the middle part. Weights are placed at one end of the rocker, and at other end, a scraper is arranged to have adaptable movement and matched with the inner wall of the inner cylinder. The arm support and the rocker can be connected using a shaft or in other ways.

Due to the role of weights, the leverage principle ensures that the scraper can always be attached to the inner surface of the inner cylinder. When the inner cylinder rotates constantly in the production process, the inner wall moves against the scraper, which is able to timely remove the coking part attached to the inner wall. Also due to the presence of weights, the deformation of the cylinder would not lead to the separation of the scraper from its inner wall. The scraper can be adaptable to keep the consistent removing operation.

The described weights are fixed to the rocker through the shaft, or connected in other ways. This helps when the cylinder deforms or the scraper attached to the inner wall is unable to remove the coking, the weights can quickly change its own position to adapt to the scraper. Particularly, in the case when the scraper fails to remove the coking body, it can automatically retreat and dodge such coking so as to avoid the damage to the scraper and the cylinder. After the scraper leaves the coking, it again automatically attaches to the inner wall with the help of weights for further removing work.

There is a fixing bracket in the inner chamber of the rotary inner cylinder of cracking device, where the arm support is mounted onto the bracket by means of a hinge. These brackets are shaped like a wheel, with the arm support being fixed to the center of the bracket. The fixing bracket is generally designed for a cracking device. This not only guarantees the length of the cylinder of a cracking device, but also to achieve continuous production in a powerful manner. These brackets function to hold the rotary cylinder. The above coking remover is usually mounted onto these brackets by way of a hinge. This way provides that both are not interfered to each other, and the cylinder has enough strength. These brackets are shaped like a wheel, with the arm support being fixed to the center. This arrangement enables the arm support to shy from the brackets to facilitate the movement of the scraper. These brackets are arranged discontinuously in the cracking device, the same as the chosen coking remover. To guarantee the removing effects, the scraper can be extended axially from the cracking device. This would reach out into the inner wall between the two brackets. At the same time, this may be achieved by way of setting more coking removers, depending on the specific production process.

By using the present process and equipment, the residual heat in the cracking device is possible to be fully utilized to be able to adjust the reaction temperature of the whole pyrolysis process, leading to an obvious decrease of temperature difference. As a result, this prevents the presence of coking in the reaction process. Supplemented by a special removing device in the device, the coking problem can be resolved once for all. The reaction efficiency is enhanced and the burden of the equipment lessened. To add it, the life span is extended with the production cost and energy consumption to be reduced.

### ILLUSTRATION

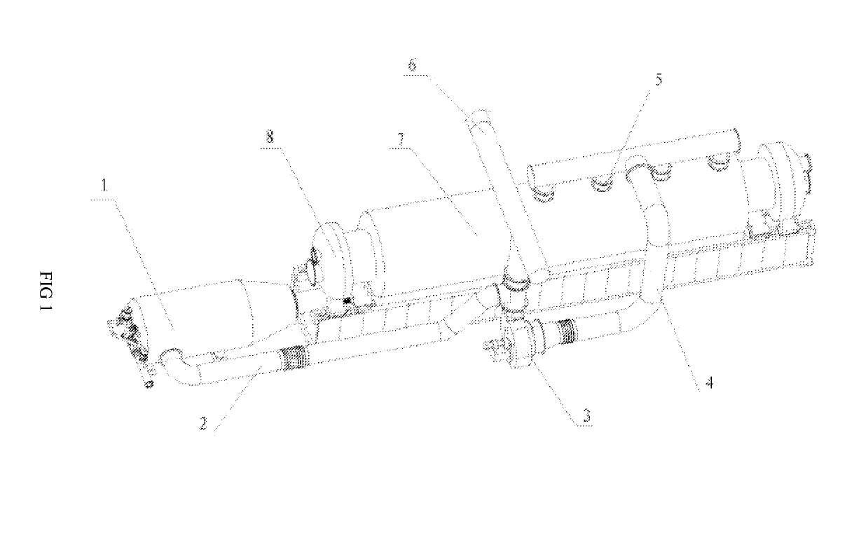

FIG. 1 is the structure diagram of the described anti-coking equipment.

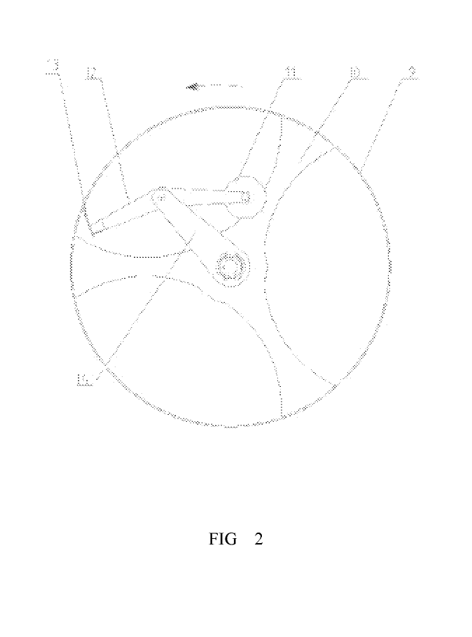

FIG. 2 is the structure diagram of the described coking remover in the cracking device.

Here, 1—Heating Devices, 2 and 4—Return Air Pipeline, 3—Hot Air Fan, 5—Hot Air Outlet, 6—Air Exhaust Pipeline, 7—Cracking Device, 8—Seal for the Cracking Device, 9—Rotary Cylinder of the Cracking Device, 10—Brackets 11,—Weights 12—Rocker, 13—Scraper, 14—Arm Support

In FIG. 2, the arrow indicates the rotary direction of the cylinder in the cracking device.

### IMPLEMENTATION

Process Implementation Instance 1

An anti-coking process, by which the hot air exhausted from the cracking device, is conveyed, through the pipeline, to the outlet, where it is mixed with the high-temperature hot air ready to be sent into the cracking device. After that, it comes into the hot air chamber. According to the measurements, the temperature of the hot air discharged from the cracking device is 410-420°, and the temperature at the outlet of the heating device (before mixing) is 1200°. When mixing is over, the temperature of the hot air on the inner wall is 500-550°, and at the product outlet, the temperature gets 380-400°. The coking condition is improved.

Process Implementation Instance 2

An anti-coking process, by which the hot air exhausted from the cracking device is conveyed via the pipeline directly to the returned hot air fan, after the increase of the air volume through the hot air fan, to the inlet of the cracking device for hot air, where it is mixed with the high-temperature hot air ready to be sent into the cracking device. According to the measurements, the temperature of the hot air discharged from the cracking device is 410-420°, and the hot air temperature at the outlet of the heating device is 1300°. After the increase of the air volume by the fan, the temperature of the remixed hot air on the inner wall is 520-540°, and at the oil & gas outlet, the temperature gets 380-400°. The anti-coking condition is improved.

Process Implementation Instance 3

An anti-coking process, in which the thermal control device is used to measure the temperature differences at the outlet of hot air, has an air control valve being placed to adjust the air volume at the outlet. The hot air exhausted from the air outlet is conveyed, after being mixed through the pipeline, directly back to the hot air fan. After the air volume is increased through the hot air fan, it is sent to the hot air inlet and mixed in the special chamber with the high-temperature hot air ready to be sent into the cracking device, followed by coming into the hot air chamber of the cracking device. According to the measurements, the temperature of the hot air discharged from the cracking device is 400-410°, and the temperature at the outlet of the heating device is 1270°. After the increase of the air volume by the hot air fan, the hot air exhausted out of the cracking device is re-mixed with the high-temperature hot air ready to be sent in the cracking device at a ratio of 2-2.5:1; the temperature of the remixed hot air acting on the inner wall is 500-530°, and at the oil & gas outlet, the temperature gets 380-400°. The coking condition is down by 55% compared to that before the use of this process.

Process Implementation Instance 4

An anti-coking process, in which the thermal control device is used to measure the temperature differences at the outlet of hot air, has an air control valve being placed to adjust the air volume at the outlet. The hot air exhausted from the air outlet is conveyed, after being mixed through the pipeline, back to the hot air fan. After the air volume is increased through the returned hot air fan, it is sent to the hot air inlet where it is mixed with the high-temperature hot air ready to be sent into the cracking device. Based on the hot air volume exhausted from the cracking device, the hot air inlet valve for the high-temperature is adjusted at a ratio of 2.5-3:1, before it comes into the hot air chamber. According to the measurements, the temperature of the hot air discharged from the cracking device is 400-410°, and the temperature at the air outlet of the heating device is 1350°. After the mixing treatment, the temperature of the hot air acting on the inner wall is 530-550°, and at the oil & gas outlet, the temperature gets 380-400°. The coking condition is down by 60% compared to that before the use of this process.

To prevent the coking from being present inside the cracking device for any other reasons, especially on the rotary inner wall of the inner cylinder of the cracking device, this present invention introduces a coking remover, which is placed on the rotary inner wall of the cracking device, and able to complete the continuous operation by working with the inner wall. This kind of scraper allows the removing operation to be done without causing any damage to the inner wall.

Process Implementation Instance 5

An anti-coking process, in which the thermal control device is used to measure the temperature differences at the outlet of hot air, has an air control valve being placed to adjust the air volume at the outlet. The hot air exhausted from the air outlet is conveyed, after being mixed through the pipeline, back to the hot air fan. After the air volume is increased through the returned hot air fan, it is sent to the hot air inlet where it is mixed with the high-temperature hot air ready to be sent into the cracking device. Based on the hot air volume exhausted from the cracking device, the hot air inlet valve for the high-temperature is adjusted at a ratio of 6-7:1, before it comes into the hot air chamber. According to the measurements, the temperature of the hot air discharged from the cracking device is 400-410°, and the temperature at the air outlet of the heating device is 1350°. After the mixing treatment, the temperature of the hot air acting on the inner wall is 520°, and at the oil & gas outlet, the temperature gets 380-400°. The temperature difference inside the cracking device is 120°. The coking condition is down by 70% compared to that before the use of this process.

To prevent the coking from being present inside the cracking device for any other reasons, especially on the rotary inner wall of the inner cylinder of the cracking device, this present invention introduces a coking remover, which is placed on the rotary inner wall of the cracking device, and able to complete the continuous operation by working with the inner wall. This kind of scraper allows the removing operation to be done without causing any damage to the inner wall.

Equipment Implementation Instance 1

Aimed at Process Implementation Instance 1, a kind of equipment applied to such process is provided, including a cracking device with a rotary cylinder. On the outer wall of the hot air chamber in the cracking device, there is a hot air outlet, which is connected via the returned air pipeline to the air inlet mixing chamber. This chamber is part of the pipeline of heating device, the heat source for the cracking device, and it is connected to the hot air chamber of the cracking device through the pipeline.

Equipment Implementation Instance 2

Aimed at Process Implementation Instance 1, a kind of equipment applied to such process is provided, including a cracking device with a rotary cylinder. On the outer wall of the hot air chamber in the cracking device, there are 3 hot air outlets, each of which is set with a volume valve. All the outlets are connected via the returned air pipeline to the returned hot air fan, followed by access to the air inlet mixing chamber. At one end of the mixing chamber, the air inlet for the heating device is designed, and connected to the hot air chamber in the cracking device.

Equipment Implementation Instance 3

Aimed at Process Implementation Instance 2, a kind of anti-coking equipment applied to such process is provided, including a cracking device with a rotary inner cylinder. On the outer wall of the cylinder of the hot air chamber in the cracking device, there are 4 hot air outlets, each of which is set with an air volume valve. All the hot air outlets are connected via the pipeline, followed by access to the mixing chamber in front of the hot air inlet of the cracking device through the returned air pipeline. At one end of the air inlet mixing chamber, the air inlet for the heating device is designed, and the air inlet mixing chamber is connected to the hot air chamber in the cracking device. Hot air recovered at the outlet of the cracking device is mixed with the high-temperature hot air in the air inlet mixing chamber. The returned air pipeline is connected with a returned hot air fan.

Equipment Implementation Instance 4

Aimed at Process Implementation Instances 2 and 3, a kind of anti-coking equipment applied to such process is provided, including a cracking device with a rotary inner cylinder. On the outer wall of the cylinder of the hot air chamber in the cracking device, there are 2 hot air outlets, each of which is set with an air volume valve. All the hot air outlets are connected via the pipeline, followed by access to the mixing chamber in front of the hot air inlet of the cracking device through the returned air pipeline. At one end of the air inlet mixing chamber, the air inlet for the heating device is designed, and the air inlet mixing chamber is connected to the hot air chamber in the cracking device. Hot air recovered at the outlet of the cracking device is mixed with the high-temperature hot air in the air inlet mixing chamber. The returned air pipeline is connected with a hot air fan, on which there is an air exhausting pipe.

Equipment Implementation Instance 5

Aimed at Process Implementation Instances 4 and 5, a kind of automatic coking removing equipment applied to such process is provided, including a cracking device with a rotary inner cylinder. On the outer wall of the cylinder of the hot air chamber in the cracking device, there are 2 hot air outlets, each of which is set with an air volume valve. All the hot air outlets are connected via the pipeline, followed by access to the mixing chamber in front of the hot air inlet of the cracking device through the returned air pipeline. At one end of the air inlet mixing chamber, the air inlet for the heating device is designed, and the air inlet mixing chamber is connected to the hot air chamber in the cracking device. Hot air recovered at the outlet of the cracking device is mixed with the high-temperature hot air in the inlet mixing chamber. The returned air pipeline is connected with a hot air fan, on which there is an air exhausting pipe.

The mentioned cracking device has a rotary inner cylinder that is mounted to the fixing seal at both ends. In the inner cylinder is set with an arm support fixed to the seal, and with a rocker being connected in the middle part. Weights are placed at one end of the rocker, and at other end, a scraper is arranged to have adaptable movement and matched with the inner wall of the inner cylinder.

Equipment Implementation Instance 6

Aimed at Process Implementation Instances 4 and 5, a kind of equipment is provided for the application of the process and automatic coking removing purposes, including a cracking device with a rotary inner cylinder. On the outer wall of the cylinder of the hot air chamber in the cracking device, there are 2 hot air outlets, each of which is set with an air volume valve. All the outlets are connected via the pipeline, followed by access to the air import mixing chamber in front of the hot air inlet of the cracking device. At one end of the air import mixing chamber, the air inlet for the heating device is designed, and connected to the hot air chamber in the cracking device. Hot air recovered at the outlet of the cracking device is mixed with the high-temperature hot air in the air import mixing chamber. The air return pipeline is placed with a returned hot air fan, on which there is an air exhausting pipe on the air return pipeline.

Some brackets are mounted in the inner chamber of the inner rotary cylinder, arranged like a wheel. The mentioned an inner rotary cylinder in the cracking device mounted to the fixing seal at both ends. In the cylinder is set with an arm support fixed to the seal, and with a rocker being connected in the middle part through the shaft. Weights are placed at one end of the rocker, and at other end, a scraper is arranged to have adaptable movement with the inner wall of the inner rotary cylinder of the cracking device. The weights are placed on the rocker through the shaft.

Equipment Implementation Instance 7

Aimed at Process Implementation Instances 4 and 5, a kind of equipment is provided for the application of the process and automatic coking removing purposes, including a cracking device with a rotary inner cylinder. On the outer wall of the cylinder of the hot air chamber in the cracking device, there are 4 hot air outlets, each of which is set with an air volume valve. All the outlets are connected via the pipeline, followed by access to the air import mixing chamber in front of the hot air inlet of the cracking device. At one end of the air import mixing chamber, the air inlet for the heating device is designed, and connected to the returned hot air chamber in the cracking device. Hot air recovered at the outlet of the cracking device is mixed with the high-temperature hot air in the air import mixing chamber. The air return pipeline is placed with a hot air fan, on which there is an air exhausting pipe on the air return pipeline.

Some brackets are mounted in the inner chamber of the cylinder, arranged like a wheel. The mentioned cracking device has a rotary cylinder that is mounted to the fixing seal at both ends. In the cylinder is set with an arm support fixed to the seal, and with a rocker being connected in the middle part through the shaft. Weights are placed at one end of the rocker, and at other end, a scraper is arranged to have adaptable movement with the inner wall of the inner rotary cylinder of the cracking device. The weights are placed on the rocker through the shaft. The length of the scraper axially extended from the cracking device equals to the distance between the two neighboring brackets.

Equipment Implementation Instance 8

Aimed at Process Implementation Instances 4 and 5, a kind of equipment is provided for the application of the process and automatic coking removing purposes, including a cracking device with a rotary inner cylinder. On the outer wall of the cylinder of the hot air chamber 9 in the cracking device 7, there are 4 hot air outlets 5, each of which is set with an air volume valve. All the outlets are connected via the pipeline 2 and 4, followed by access to the air import mixing chamber in front of the hot air inlet of the cracking device. At one end of the air import mixing chamber, the inlet for the heating device 1 is designed, and connected to the returned hot air chamber in the cracking device. Hot air recovered at the outlet of the cracking device is mixed with the high-temperature hot air in the air import mixing chamber. The air return pipeline is placed with a hot air fan 3, on which there is an air exhausting pipe 6 on the air return pipeline.

Some brackets 10 are mounted in the inner chamber of the cylinder, arranged like a wheel. The mentioned rotary cylinder 9 in the cracking device mounted to the fixing seal at both ends. In the cylinder 9 is set with an arm support 14 fixed to the seal 8, where the arm support 14 is mounted by means of a hinge at the center. With a hinge, it is mounted onto the bracket 10, with the arm support located in the center. There are 3 arm supports between the neighboring brackets. In the middle part of the arm support 14, there is a rocker 12 connected through the shaft. Weights 11 are placed at one end of the rocker 12, and at other end, a scraper 13 is arranged to have adaptable movement with the inner wall of the inner rotary cylinder in the cracking device. The weights 11 are placed on the rocker 12 through the shaft. The length of the scraper on the 3 arm-supports axially extended from the cracking device equals to the distance between the two neighboring brackets.

1. An anti-coking process for oiling equipment wherein: The hot air discharged from the pyrolysis process is mixed with the high-temperature hot air before being sent into the cracking device, so as to lower the temperature difference inside the cracking device.

2. According to the anti-coking process described in claim 1, wherein: The hot air discharged from the pyrolysis process is mixed with the high-temperature hot air after its volume is adjusted.

3. According to the anti-coking process described in claim 1, wherein: The pyrolysis process comes along with the coking removal on the inner wall of the cracking device by using the remover.

4. According to the anti-coking process described in claim 3, wherein: The coking removal process is automatically and continuously completed.

5. According to the anti-coking process described in claim 4, wherein: The described automatically continuous coking removal is completed with the help of the scraper that is automatically adaptable to the surface of the inner wall of the cracking device.

6. As described in claim 1, this is a kind of anti-coking process for oiling equipment, including a cracking device with a rotary cylinder, wherein: The outer wall of the hot air chamber is designed with one or more hot air outlets (5), which get an access to the inlet mixing chamber via the return air pipeline (4), the mixing chamber has an air inlet to the heating device, access to the air inlet to the hot air chamber.

7. As described in claim 7, wherein: The hot air outlet (5) is set with an air valve for volume control.

8. As described in claim 6 or 7, wherein: The described return air pipeline (4) is set with a device for the adjustment of air volume.

9. As described in claim 6 or 7 or 8, wherein: The described return air pipeline (4) is connected to air exhaust pipeline (6) via a device for the adjustment of air volume.

10. As described in claim 6, wherein: The described rotary inner cylinder (9) of the cracking device is mounted on the fixing seals at both ends. Inside the inner cylinder (9) is set with an arm support (14) being fixed to the seals (8) and a rocker (12) fixed to the arm support (14) in the middle part; at one end of the rocker (12) is placed with weights (11) and the other end with a scraper (13), which is able to move against the round inner wall of the cylinder in the cracking device.

11. As described in claim 10, wherein: The described weights (11) are mounted onto the rocker (12) through the shaft.

12. As described in claim 10 or 11, wherein: The rotary inner cylinder (9) in the cracking device is fixed with some brackets (10) in the chamber, where the arm support (14) is hinged to the brackets (10).

13. As described in claim 12, wherein: The brackets (10) are arranged like a wheel, where the arm support (14) is mounted in the center thereof.

14. An automatic coking remover for the oiling equipment, wherein: it includes an arm support (14) set in the rotary inner cylinder (9) of the cracking device being fixed to the seals (8) and a rocker (12) fixed to the arm support (14) in the middle part. At one end of the rocker (12) is placed with weights (11) and the other end with a scraper (13), which is able to move against the round inner wall of the cylinder in the cracking device.

15. As described in claim 14, wherein: The described weights (11) are mounted onto the rocker (12) through the shaft.

16. As described in claim 14 or 15, wherein: The described rotary inner cylinder (9) of the cracking device is mounted on the fixing seals at both ends. The rotary cylinder (9) in the cracking device is fixed with some brackets (10) in the chamber, where the arm support (14) is hinged to the brackets (10).

17. As described in claim 16, wherein: The brackets (10) are arranged like a wheel, where the arm support (14) is mounted in the center thereof.
